(19) United States
(12) Patent Application Publication
(10) Pub. No.: US 2008/0237455 A1
(43) Pub. Date: Oct. 2, 2008

(54) LIGHT RECEIVING APPARATUS

(75) Inventors: Tomohiko ISHIDA, Tokyo (JP); Jun ONO, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 12/053,060

(22) Filed: Mar. 21, 2008

(30) Foreign Application Priority Data
Mar. 26, 2007 (JP) 2007-078091

(51) Int. Cl. H01J 5/02

(52) U.S. Cl. 250/239

(57) ABSTRACT

A light receiving apparatus includes a holder made of metal and a light receiving element that is attached to the holder, receives laser light reflected by an information medium, and outputs an electric signal. The light receiving element is constructed of a bare chip, is attached to the holder, and parts of the light receiving element aside from a part on which the laser light is incident are sealed using resin.

### BACKGROUND OF THE INVENTION

1. Field of the Invention

The present invention relates to a light receiving apparatus that includes a holder made of metal and a light receiving element that is attached to the holder, receives laser light reflected by an information medium, and outputs an electric signal.

2. Description of the Related Art

A light receiving apparatus used in an optical head normally includes an integrated circuit element in which a light receiving element (light receiving unit) is formed, a circuit board on which the integrated circuit element is mounted, a wiring substrate on which the circuit board is mounted, and a holder that supports the circuit board, reinforces the wiring substrate, and also functions as a heat dissipation plate. In such construction, electrode terminals formed on the integrated circuit element and electrode terminals formed on the circuit board are connected by wires, and terminals formed on the circuit board on which the integrated circuit element is mounted and terminals formed on the wiring substrate are connected by soldering. With this construction, laser light received by the light receiving element is converted to and transmitted as an electric signal. Here, the expression “electric signal” includes a reproducing signal that includes information recorded on an optical recording medium and an error detection signal used to adjust focus errors or tracking errors for the optical head. A light receiving apparatus disclosed by Japanese Laid-Open Patent Publication No. H08-306939 is known as one example of a light receiving apparatus with a different construction (see FIG. 1 and FIG. 3 of the publication) to the light receiving apparatus of the optical head described above. This light receiving apparatus is installed in a reproducing apparatus for an optical disc (information medium) such as a DVD or CD, and includes a metal plate, a light receiving element, and a flexible circuit board. An insulating layer and land portions are formed on a first surface of the metal plate. A through-hole for allowing light reflected from the optical disc to pass is formed in the center of the metal substrate. The light receiving element is composed of a rectangular package and lead portions that extend in two directions from both side surfaces of the package, and is mounted on the first surface of the metal plate on which the insulating layer has been formed in a state where the light receiving surface of the light receiving element faces the through-hole. The lead portions of the light receiving element and the flexible circuit board are respectively connected to the land portions formed on the first surface of the metal plate.

### SUMMARY OF THE INVENTION

However, by investigating the light receiving apparatuses described above, the present inventors found the following problem. In the light receiving apparatus described above that includes the circuit board, since signals are transmitted via the circuit board on which the light receiving element is mounted and the wiring board, the total thickness is increased by the thickness of the circuit board. On the other hand, as drive apparatuses are made smaller and slimmer, there are also demands to make the light receiving apparatus smaller and slimmer. However, in the light receiving apparatus described above, it is difficult to make the light receiving apparatus thinner due to the thickness required for the circuit board. There is also a tendency for an increasing amount of heat to be generated from a light receiving element that has received laser light, and it is therefore preferable to construct the light receiving apparatus so as to be capable of efficiently dissipating heat from the light receiving element. To efficiently dissipate heat, the light receiving element needs to be provided near the holder. However, in the light receiving apparatus described above, since the circuit board is present between the holder and the light receiving element, the light receiving element cannot be provided sufficiently near the holder. Also, in the light receiving apparatus disclosed in Japanese Laid-Open Patent Publication No. H08-306939, since the light receiving element is packaged, the light receiving element cannot be provided sufficiently near the metal plate.

The present invention was conceived in view of the problem described above and it is a principal object of the present invention to provide a light receiving apparatus that can be made smaller and slimmer and has improved heat dissipation. It is a further object to provide a light receiving apparatus that can be manufactured according to a simple method.

To achieve the stated object, a light receiving apparatus according to the present invention includes: a holder made of metal; and a light receiving element that is attached to the holder, receives laser light reflected by an information medium, and outputs an electric signal, wherein the light receiving element is constructed of a bare chip, is attached to the holder, and parts of the light receiving element aside from a part on which the laser light is incident are sealed using resin.

With the light receiving apparatus according to the present invention, by attaching a bare chip as the light receiving element to the holder that is made of metal, the bare chip is directly mounted on the metal holder with no circuit board or attachment member provided between the bare chip and the holder, and therefore the entire thickness of the light receiving apparatus can be reduced by the thickness of a circuit board or the like. Accordingly, it is possible to make the light receiving apparatus sufficiently smaller and slimmer. Since the bare chip is directly attached to the holder without a circuit board or an attachment member in between, even if the bare chip heats up due to laser light being received, such heat can be dissipated with high efficiency via the holder. Accordingly, it is possible to sufficiently improve the dissipation of heat. Also, by sealing parts of the bare chip aside from the part on which the laser light is incident using the resin, the state where the part where laser light is incident is exposed and not covered with the resin is maintained, so that it is possible to reliably prevent deterioration in the resin due to laser light of a short wavelength being transmitted through the resin.

Here, it is possible to use a construction where conductive patterns are formed on the holder, first ends of the conductive patterns are connected via conductive wires to connection terminals of the bare chip, and second ends of the conductive patterns are connected to wiring patterns of a flexible substrate. By using this construction, since it is possible to use a flexible substrate of a simple form (i.e., with simple wiring patterns) without using a flexible substrate of a complex form (i.e., with complex wiring patterns), the light receiving apparatus can be constructed at low cost. Here, although a construction that uses a flexible substrate as a wiring substrate on which the conductive patterns like those described above is also conceivable, there would be a problem when connecting the bare chip and the conductive patterns of the flexible substrate by wires in a state where the flexible substrate has been stuck (bonded) onto the holder using resin or the like in that it would be difficult to make the wire connections due to the influence of the resin used for the bonding. Also, although it would also be conceivable to stick the flexible substrate on which the conductive patterns described above are formed to the holder after the bare chip has been connected by wires to the flexible substrate, with such method, there is the risk of the wire connections becoming easily broken during the sticking process. This means that extreme care would be required during handling, resulting in a corresponding drop in manufacturing efficiency. On the other hand, with the light receiving apparatus according to the present invention, since conductive patterns are formed on the metal holder and the bare chip is connected by wires to the conductive patterns formed on the holder without a circuit board, such as a flexible substrate in between, it is possible to manufacture the light receiving apparatus with a simple and highly reliable method of manufacturing where handling is easy. Also, since it is possible to prevent the wire connections from being broken, the reliability of the light receiving apparatus can also be sufficiently improved.

It is also possible to use a construction where the holder is formed of aluminum as the metal. With this construction, it is possible to dissipate heat generated by the bare chip with significantly improved efficiency.

It should be noted that the disclosure of the present invention relates to a content of Japanese Patent Application 2007-078091 that was filed on 26 Mar. 2007 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a schematic diagram showing the construction of an optical pickup apparatus;

FIG. 2 is a schematic diagram of a light receiving apparatus and a flexible substrate;

FIG. 3 is a cross-sectional view of a holder in a state where the surface of the holder is being cleaned;

FIG. 4 is a cross-sectional view of the holder in a state where a buffer metal layer has been formed;

FIG. 5 is a cross-sectional view of the holder in a state where a metal mask has been formed;

FIG. 6 is a cross-sectional view of the holder in a state where an insulating film has been formed;

FIG. 7 is a cross-sectional view of the holder in a state where the metal mask has been removed;

FIG. 8 is a cross-sectional view of the holder in a state where a photoresist layer has been formed;

FIG. 9 is a cross-sectional view of the holder in a state where patterns have been formed in the photoresist layer;

FIG. 10 is a cross-sectional view of the holder in a state where metal has been deposited;

FIG. 11 is a cross-sectional view of the holder in a state where the photoresist layer has been separated;

FIG. 12 is a cross-sectional view of the holder in a state where a photoresist layer has been formed;

FIG. 13 is a cross-sectional view of the holder in a state where patterns have been formed in the photoresist layer;

FIG. 14 is a cross-sectional view of the holder in a state where a protective film has been formed;

FIG. 15 is a cross-sectional view of the holder in a state where the photoresist layer has been separated;

FIG. 16 is a cross-sectional view of the holder in a state where another photoresist layer has been formed;

FIG. 17 is a cross-sectional view of the holder in a state where patterns have been formed in the other photoresist layer;

FIG. 18 is a cross-sectional view of the holder in a state where parts of the protective film have been removed;

FIG. 19 is a cross-sectional view of the holder in a state where the other photoresist layer has been separated;

FIG. 20 is a cross-sectional view of the holder in a state where a bare chip has been attached;

FIG. 21 is a cross-sectional view of the holder in a state where electrodes of the bare chip and electrodes have been connected by wires;

FIG. 22 is a cross-sectional view of the holder in a state after sealing with a thermosetting liquid-state sealing resin;

FIG. 23 is a cross-sectional view of another light receiving apparatus;

FIG. 24 is a cross-sectional view of another light receiving apparatus; and

FIG. 25 is a cross-sectional view of another light receiving apparatus.

### DESCRIPTION OF THE PREFERRED EMBODIMENTS

Preferred embodiments of a light receiving apparatus according to the present invention will now be described with reference to the attached drawings.

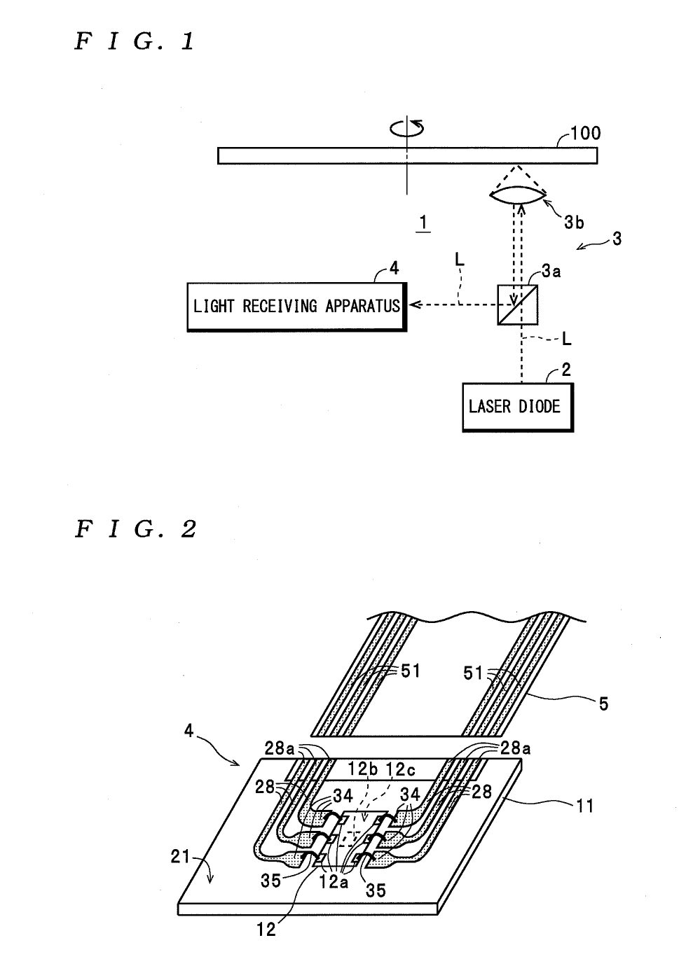

First, the construction of an optical pickup apparatus 1 will be described with reference to the drawings. The optical pickup apparatus 1 shown in FIG. 1 is an optical pickup apparatus used in an apparatus for reproducing (or recording and reproducing) data recorded on an information medium 100 such as a BD (Blu-Ray Disc (registered trademark)), a DVD and a CD, and as shown in FIG. 1, includes a laser diode 2, an optical system 3, and an optical pickup light receiving apparatus (hereinafter simply “light receiving apparatus”) 4.

The laser diode 2 is a three-wavelength laser diode and is capable of outputting (emitting) laser light of three bands that are 405 nm-band laser light that is required for reproducing a BD, 650 nm-band laser light that is required for reproducing a DVD, and 780 nm-band laser light that is required for reproducing a CD. As one example, the optical system 3 includes a prism 3a and a focusing lens 3b. The optical system 3 focuses laser light L outputted from the laser diode 2 onto the information medium 100 using the focusing lens 3b and refracts laser light L reflected by the information medium 100 using the prism 3a toward a light receiving apparatus 4 to guide the reflected light to the light receiving apparatus 4.

The light receiving apparatus 4 is one example of a “light receiving apparatus” according to the present invention and, as shown in FIG. 2, includes a holder 11 and a bare chip 12. The holder 11 is a base on which the bare chip 12 is mounted and is constructed of a rectangular aluminum plate. A plurality of conductive patterns 28 are formed on the surface 21 of the holder 11. As shown in FIG. 2, at respective first ends of the conductive patterns 28, electrodes 34 that are connected by wires 35 (“conductive wires” for the present invention) are formed at positions next to connection terminals 12a of the bare chip 12 attached to the holder 11. Also, as shown in FIG. 2, the conductive patterns 28 are disposed so that the pitch of respective second ends 28a thereof (i.e., the distance between adjacent conductive patterns 28) is equal to the pitch of wiring patterns 51 (i.e., the distance between adjacent wiring patterns 51) of a flexible substrate 5 (a film-like wiring substrate) used for wiring, so that the conductive patterns 28 can be easily connected to the wiring patterns 51. Note that in FIG. 2 to FIG. 25 referred to by these embodiments, for ease of understanding the present invention, the lengths, widths, and thicknesses of the respective component elements are not necessarily shown with the same proportions in all of the drawings.

The bare chip 12 includes three light receiving units that respectively correspond to the three bands of laser light L described above, a control circuit, an amplification circuit, and a converter circuit (none of which is shown). In this example, the bare chip 12 is constructed as a single semiconductor element (PDIC) where the respective light receiving units and circuits are formed on a silicon wafer. The bare chip 12 is not packaged and is directly attached to the surface 21 of the holder 11 using an epoxy adhesive that conducts electricity without an attachment member being provided between the bare chip 12 and the holder 11. The connection terminals 12a and the electrodes 34 of the conductive patterns 28 formed on the holder 11 are connected using wires 35. Each light receiving unit receives laser light L reflected by the information medium 100 and outputs a current in keeping with the intensity of the laser light L, and the converter circuit includes, for example, an amplifier, an output buffer, a feedback circuit, and the like. Here, the converter circuit converts the output current from the light receiving unit to a voltage and amplifies the converted voltage by a predetermined gain.

Next, a method of manufacturing the light receiving apparatus 4 according to a light receiving apparatus manufacturing procedure will be described with reference to the drawings.

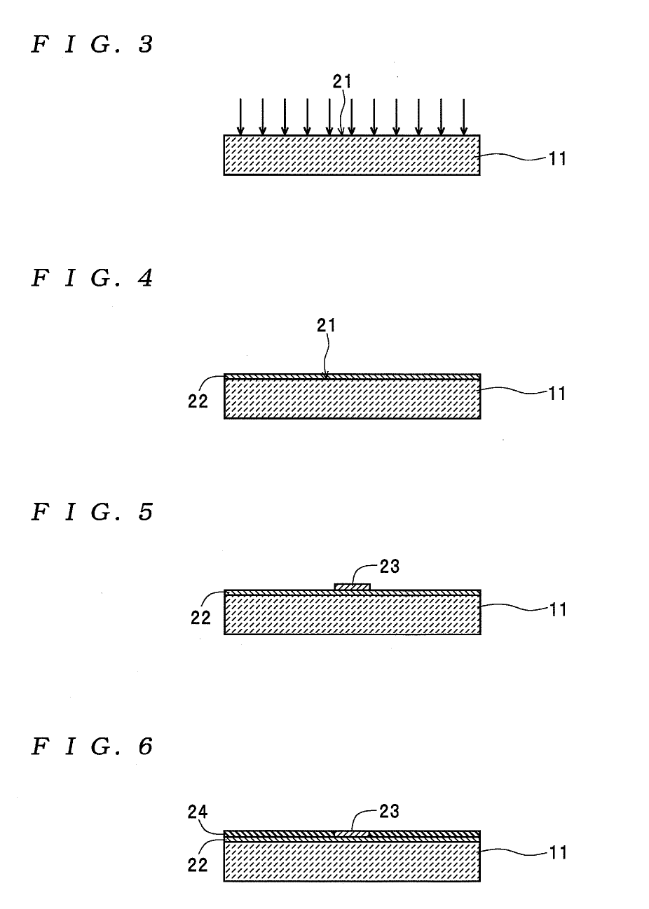

First, as shown in FIG. 3, plasma is emitted onto the surface 21 of the holder 11 to clean the surface 21. After this, as shown in FIG. 4, a buffer metal layer 22 is formed on the surface 21 of the holder 11 that has been cleaned. Next, as shown in FIG. 5, the part of the buffer metal layer 22 to which the bare chip 12 will be attached is masked by a metal mask 23. After this, alumina (i.e., aluminum oxide) is deposited at parts aside from the part masked by the metal mask 23 to form an insulating film 24 made of alumina on the buffer metal layer 22 as shown in FIG. 6.

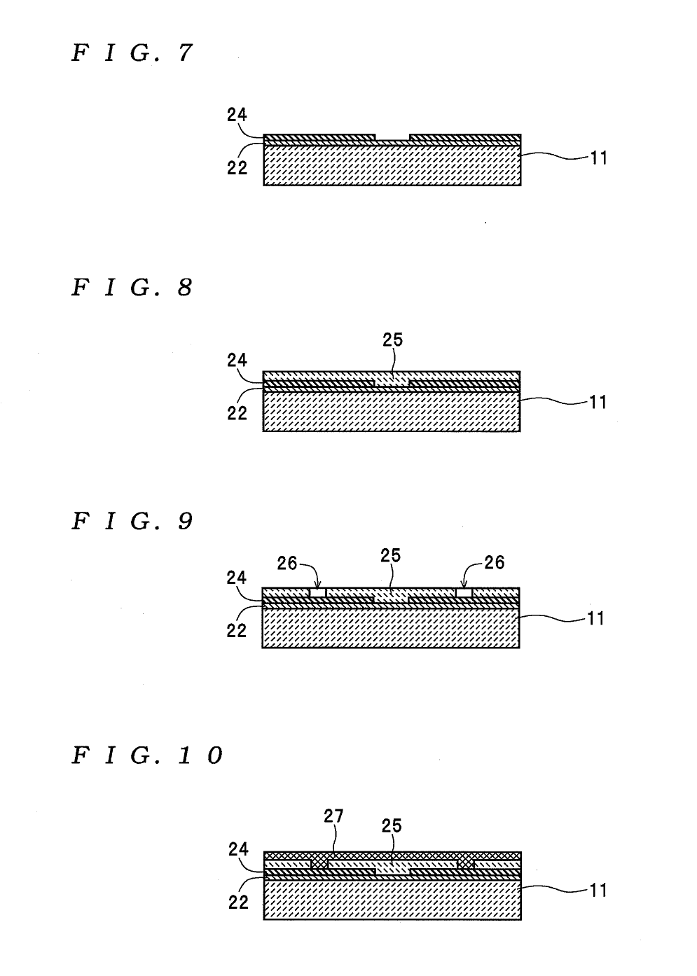

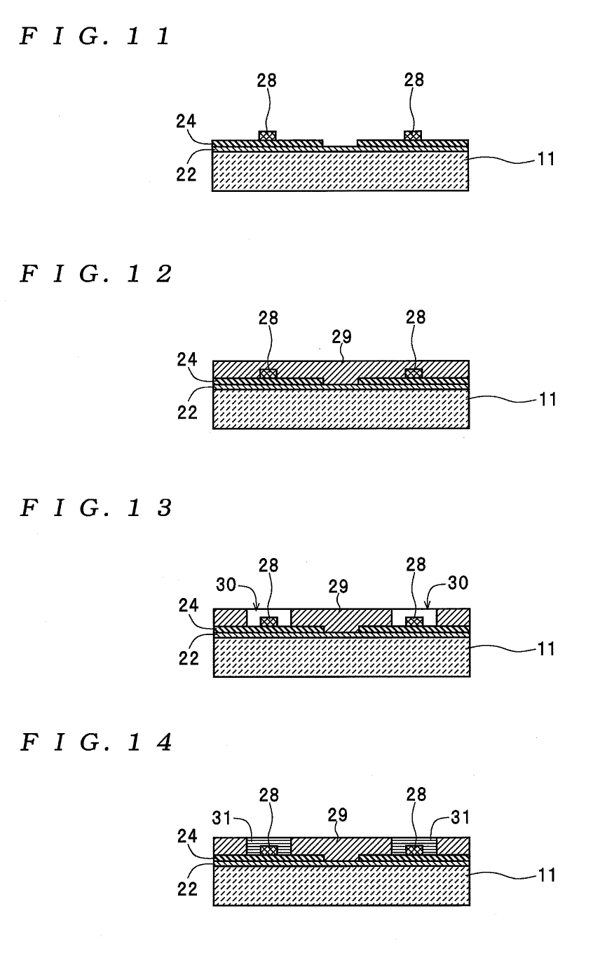

Next, as shown in FIG. 7, the metal mask 23 is removed, and as shown in FIG. 8, a positive photoresist is applied to form a photoresist layer 25. After this, as shown in FIG. 9, patterns 26 corresponding to the conductive patterns 28 are formed in the photoresist layer 25 by carrying out a developing process. Next, as shown in FIG. 10, gold 27 is deposited from above the photoresist layer 25 in which the patterns 26 have been formed with a buffer metal (for example, Ti—Ni) as an underlayer. After this, as shown in FIG. 11, the photoresist layer 25 is separated (removed). By doing so, the conductive patterns 28 are formed of the gold that was deposited in the patterns 26.

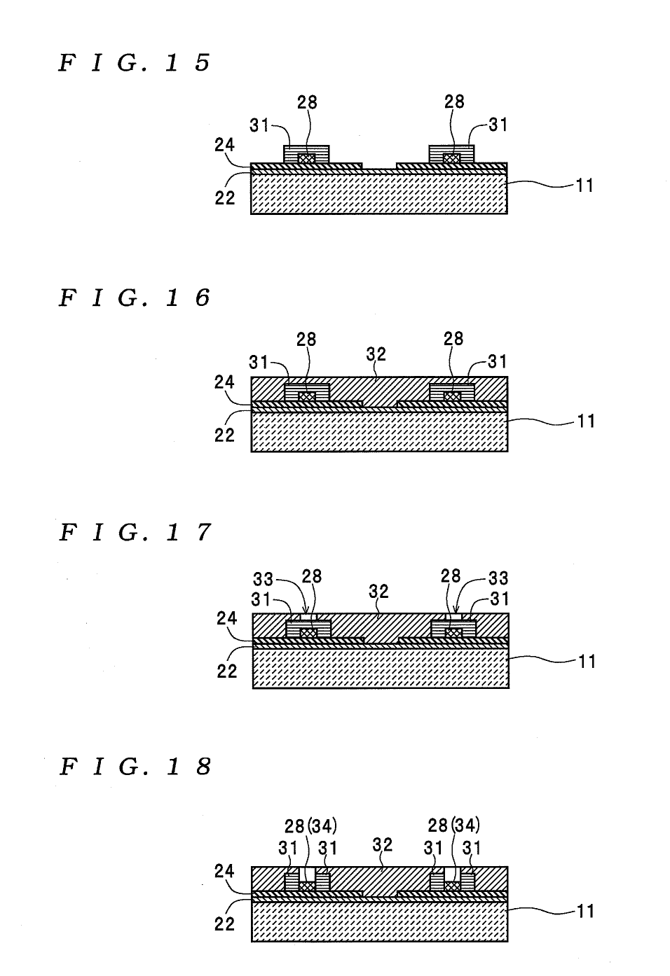

Next, as shown in FIG. 12, a positive photoresist is applied to form a photoresist layer 29. After this, by carrying out a developing process, as shown in FIG. 13, patterns 30 that cover the conductive patterns 28 are formed in the photoresist layer 29. Next, as shown in FIG. 14, polyimide is applied from above the photoresist layer 29 in which the patterns 30 have been formed to form a protective film 31 in the patterns 30, or in other words, at parts that cover the conductive patterns 28. After this, as shown in FIG. 15, the photoresist layer 29 is separated (removed).

Next, as shown in FIG. 16, a positive photoresist is applied to form a photoresist layer 32. After this, by carrying out a developing process, as shown in FIG. 17, patterns 33 are formed in the photoresist layer 32 corresponding to predetermined parts above the conductive patterns 28. Next, as shown in FIG. 18, by carrying out a dry etching process, the protective film 31 is removed at the parts where the patterns 33 are formed. By doing so, the parts where the protective film 31 has been removed, that is, the parts where the patterns 33 are formed above the conductive patterns 28 become exposed. Such exposed parts function as the electrodes 34.

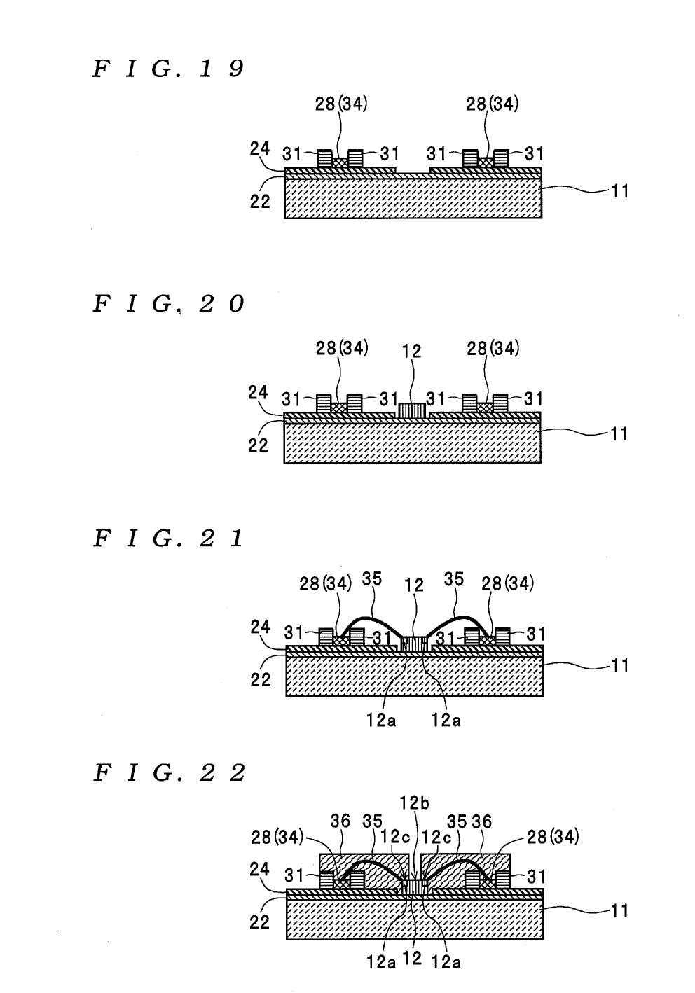

After this, as shown in FIG. 19, the photoresist layer 32 is separated. Next, as shown in FIG. 20, the bare chip 12 is attached to the surface 21 of the holder 11 on which the buffer metal layer 22 has been formed using an adhesive or the like that conducts electricity. After this, as shown in FIG. 21, the electrodes of the bare chip 12 and the electrodes 34 on the conductive patterns 28 are connected using the wires 35. Next, the electrode terminals of the bare chip 12, the electrodes 34 on the conductive patterns, and the wires 35 are sealed using a thermosetting liquid-state sealing resin 36. Here, the part of the light receiving unit on which the laser light L is incident (hereinafter such part is referred to as the “incident part 12b”) is left exposed without sealing. That is, the parts aside from the incident part 12b(hereinafter such parts are collectively referred to as the “sealed part 12c”) are sealed. By carrying out the process above, the light receiving apparatus 4 is completed.

Next, as shown in FIG. 2, the flexible substrate 5 is connected to the light receiving apparatus 4. More specifically, the respective first ends of the wiring patterns 51 on the flexible substrate 5 are connected to the respective second ends 28a of the conductive patterns 28. Here, in the light receiving apparatus 4, the second ends 28a of the conductive patterns 28 are disposed so as to have the same pitch as the pitch of the wiring patterns 51 of the flexible substrate 5. This means that by merely carrying out soldering in a state where the wiring patterns 51 corresponding to the respective conductive patterns 28 have been placed in an overlapping state, it is possible to easily connect the conductive patterns 28 and the wiring patterns 51. After this, the laser diode 2, the optical system 3, and the light receiving apparatus 4 are attached to a case, not shown. By carrying out the process above, the optical pickup apparatus 1 is completed.

Next, the operation of the optical pickup apparatus 1 will be described by way of one example of the operation of a recording/reproducing apparatus in which the light pickup apparatus 1 is installed.

First, when reproducing data recorded on the information medium 100, the wavelength and power of the laser light L outputted from the laser diode 2 are set at a wavelength corresponding to the information medium 100 by a control unit of the recording/reproducing apparatus. By doing so, laser light L of a predetermined wavelength and a predetermined power is outputted from the laser diode 2. When doing so, the outputted laser light L is focused by the focusing lens 3b of the optical system 3 onto the information medium 100 and the laser light L reflected by the information medium 100 is guided by the prism 3a to the light receiving apparatus 4.

Next, one of the light receiving units of the bare chip 12 in the light receiving apparatus 4 receives the laser light L and outputs an electric signal (as one example, a current) in keeping with the intensity of such laser light L. In the light receiving apparatus 4, the holder 11 is formed of aluminum that has high thermal conductivity and the bare chip 12 is directly attached to the holder 11 without an attachment member in between. This means that even if the bare chip 12 heats up when the laser light L is received, such heat can be dissipated with high efficiency. In the light receiving apparatus 4, the parts of the bare chip 12 aside from the incident part 12b of the light receiving units are sealed by the thermosetting liquid-state sealing resin 36. That is, a state where the incident part 12b of the bare chip 12 is not covered by the thermosetting liquid-state sealing resin 36 is maintained. This means that there is no resin above the light receiving units, which are exposed, and therefore it is possible to prevent deterioration in the resin due to the laser light L of a short wavelength being transmitted through the resin.

Next, the converter circuit of the bare chip 12 converts the current outputted from the light receiving unit to a voltage and amplifies the converted voltage by a predetermined gain. After this, a signal processing unit of the recording/reproducing apparatus carries out predetermined processing based on the voltage outputted from the converter circuit. By doing so, data recorded on the information medium 100 is reproduced.

In this way, according to the light receiving apparatus 4, by attaching the bare chip 12 as the light receiving element to the holder 11 that is made of metal, the bare chip 12 is directly mounted on the metal holder 11 with no circuit board or attachment member provided between the bare chip 12 and the holder 11 and therefore the entire thickness of the light receiving apparatus 4 can be reduced by the thickness of a circuit board or the like. Accordingly, it is possible to make the light receiving apparatus 4 sufficiently smaller and slimmer. Since the bare chip 12 is directly attached to the holder 11 without a circuit board or an attachment member in between, even if the bare chip 12 heats up due to the laser light L being received, such heat can be dissipated with high efficiency via the holder 11. Accordingly, it is possible to sufficiently improve the dissipation of heat. Also, by sealing the sealed part 12c, which corresponds to the parts of the bare chip 12 aside from the incident part 12b of the light receiving units, using the thermosetting liquid-state sealing resin 36, the state where the incident part 12b is exposed and not covered with the thermosetting liquid-state sealing resin 36 is maintained, so that it is possible to reliably prevent deterioration in the resin due to the laser light L of a short wavelength being transmitted through the resin.

Also, according to the light receiving apparatus 4, by forming the conductive patterns 28, with the electrodes 34 at first ends thereof connected via the wires 35 to the connection terminals 12a of the bare chip 12 and the second ends 28a connected to the wiring patterns 51 of the flexible substrate 5, on the holder 11, unlike a construction that uses a flexible substrate on which the same conductive patterns as the conductive patterns 28 are formed, the bare chip 23 can be connected by wires to the conductive patterns 28 formed on the holder 11 without a circuit board, such as a flexible substrate, in between. This makes it possible to manufacture the light receiving apparatus with a simple and highly reliable method of manufacturing where handling is easy. Also, unlike a method where a flexible substrate is stuck to a holder, it is possible to prevent the wire connections from being broken, which means that the reliability of the light receiving apparatus 4 can also be sufficiently improved.

Also, according to the light receiving apparatus 4, by forming the holder 11 of aluminum that has high thermal conductivity, it is possible to dissipate heat generated by the bare chip 12 with significantly improved efficiency.

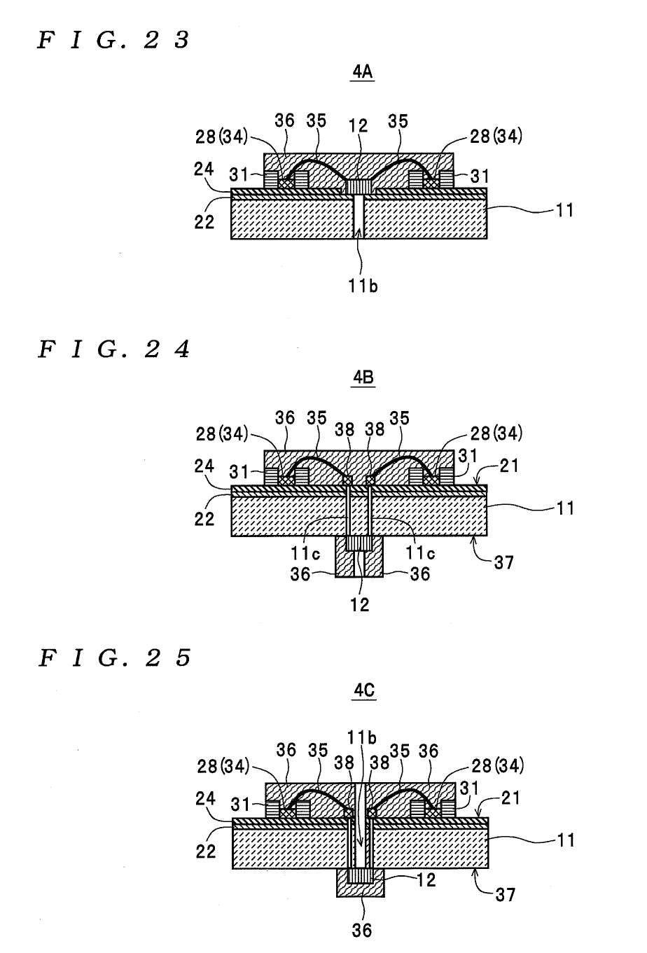

Note that the present invention is not limited to the construction described above. For example, although an example construction where the bare chip 12 is attached to the holder 11 so that the incident part 12b of the light receiving units is oriented in the opposite direction to the holder 11 (i.e., upward in FIG. 22) has been described, like a light receiving apparatus 4A shown in FIG. 23, it is also possible to use a construction where the bare chip 12 is attached to the holder 11 so that the incident part 12b is oriented toward the holder 11 (i.e., downward in FIG. 23) and a light-receiving hole 11b is formed at a position on the holder 11 that faces the incident part 12b. Note that in FIG. 23, and in FIGS. 24 and 25 described later, component elements that have the same functions as in the light receiving apparatus 4 described above have been assigned the same reference numerals and duplicated description thereof is omitted.

Also, like a light receiving apparatus 4B shown in FIG. 24, it is possible to use a construction where the bare chip 12 is attached to a rear surface (a rear surface 37 in FIG. 24) with respect to the surface (that is, the surface 21) of the holder 11 on which the conductive patterns 28 are formed, through-holes 11c for connecting the connection terminals 12a of the bare chip 12 and the terminals 38 formed on the surface 21 are formed, and the terminals 38 and the electrodes 34 are connected. In addition, like a light receiving apparatus 4C shown in FIG. 25, it is possible to use a construction where the bare chip 12 is attached to the rear surface 37 of the holder 11 so that the incident part 12b of the light receiving unit is oriented toward the holder 11.

Also, although the light receiving apparatus 4 that includes the bare chip 12 equipped with three light receiving units corresponding to the laser diode 2 as a three-wavelength laser diode has been described as an example, it is also possible to apply the present invention to a light receiving (detector) apparatus that includes a bare chip equipped with one or two light receiving units corresponding to a laser diode that outputs laser light of one or two bands. In addition, although the bare chip 12 where the light receiving units are formed in an integrated circuit with a control circuit, an amplification circuit, and a converter circuit has been described as one example of a light receiving element, the present invention is not limited to such construction. For example, a “light receiving element” for the present invention also includes a light receiving element composed of only a photodiode. The material of the holder 11 is not limited to aluminum, and it is possible to use an arbitrary metal.

What is claimed is:

1. A light receiving apparatus comprising:
a holder made of metal; and
a light receiving element that is attached to the holder, receives laser light reflected by an information medium, and outputs an electric signal,
wherein the light receiving element is constructed of a bare chip, is attached to the holder, and parts of the light receiving element aside from a part on which the laser light is incident are sealed using resin.

2. A light receiving apparatus according to claim 1,
wherein conductive patterns are formed on the holder, first ends of the conductive patterns are connected via conductive wires to connection terminals of the bare chip, and second ends of the conductive patterns are connected to wiring patterns of a flexible substrate.

3. A light receiving apparatus according to claim 1,
wherein the holder is formed of aluminum as the metal.

4. A light receiving apparatus according to claim 2,
wherein the holder is formed of aluminum as the metal.
